(19) United States
(12) Patent Application Publication
(10) Pub. No.: US 2005/0046546 A1
(43) Pub. Date: Mar. 3, 2005

(54) Passive keyless entry device

(75) Inventor: Hideki Masudaya, Miyagi-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/924,387

(22) Filed: Aug. 23, 2004

(30) Foreign Application Priority Data
Aug. 25, 2003 (JP) 2003-300187

(51) Int. Cl. G08C 19/00

(52) U.S. Cl. 340/5.61; 340/825.72; 307/10.5; 340/10.33

(57) ABSTRACT

A passive keyless entry device includes a fixed unit and a portable unit. A signal receiving section of the portable unit includes three antennas for receiving a signal which is wirelessly transmitted from the fixed unit with respect to three directions which are at right angles to one another; three amplifiers; three detectors; a selector circuit for selecting one detection output by which a wake-up signal can be detected and in which the received signal valve of the antenna is comparatively high from among the detection outputs which are output from the detectors; a level comparator; first and second switches; and a counter.

### BACKGROUND OF THE INVENTION

1. Field of the Invention

The present invention relates to a passive keyless entry device used for engine start/stop control and door locking/unlocking of an automobile. More particularly, the present invention relates to means for improving communication between a fixed unit and a portable unit by reducing the influence of interference waves affecting the portable unit.

2. Description of the Related Art

Most recent automobiles have been provided with a passive keyless entry device for remotely operating the starting/stoppage of an engine, locking/unlocking of a door by wirelessly transmitting a signal between a fixed unit disposed in an automobile and a portable unit carried by a user.

Examples of this type of passive keyless entry device include an active keyless entry device that wirelessly transmits an instruction signal from a portable unit to a fixed unit by operating a switch provided in the portable unit, and a passive keyless entry device that wirelessly transmits a wake-up signal and a data signal from a fixed unit to a portable unit and that wirelessly transmits a required instruction signal from the portable unit receiving the wake-up signal and the data signal to the fixed unit (see, for example, U.S. Pat. No. 6,317,035).

The active keyless entry device has features that prevent the occurrence of inconveniences such as, the door being erroneously unlocked, and a theft being incurred because a controlled device is not operated unless the user operates switches provided in the portable unit.

On the other hand, the passive keyless entry device has the following features. Since a controlled device can be operated automatically without operating switches provided in the portable unit, the convenience of the user can be improved even more. Furthermore, since a switch need not be provided in the portable unit, the portable unit can be made compact. In addition, since the number of instruction signals transmitted from the portable unit to the fixed unit is not limited by the number of switches provided in the portable unit, higher functionality of the keyless entry device can be easily achieved.

The passive keyless entry device has problems in that, since a circuit for receiving a wireless signal, including an antenna and a detector, is provided in the portable unit, when the portable unit is placed inside the vehicle, various electromagnetic waves emitted from the electrical components mounted in the vehicle are likely to act as interference waves on the portable unit.

Examples of radio wave interference to the portable unit include a case in which an instruction signal is erroneously transmitted from the portable unit to the fixed unit as a result of responding to electromagnetic waves emitted from a television, and a case in which electromagnetic waves emitted from a fan motor of an air conditioner, a digital amplifier of an audio unit, a harness of a discharge lamp, an ignition coil, etc., are superposed on antenna input of the portable unit, the wake-up signal is buried in the interference waves, and the portable unit cannot detect the wake-up signal.

Regarding the former case, detection of interference waves is possible by comparing the pattern of antenna input with the pattern of the transmission signal which is originally transmitted wirelessly from the fixed unit to the portable unit. When the interference waves are detected, the transmission of the instruction signal from the portable unit to the fixed unit can be prevented by not starting the circuit after that detection. This has already been put into practical use.

On the other hand, regarding the latter case, it is not possible for the portable unit to detect the wake-up signal and the data signal even with the above-described means, and the instruction signal is not transmitted to the fixed unit. Therefore, the inconvenience such that the fixed unit erroneously determines that no portable unit is present inside the vehicle in spite of the fact that the portable unit is present inside the vehicle cannot be overcome.

### SUMMARY OF THE INVENTION

The present invention has been made to solve the problems of such conventional technology. An object of the present invention is to provide a passive keyless entry device in which the reliability of communication between a fixed unit and a portable unit is high by reducing the influence of interference waves affecting the portable unit.

To achieve the above-mentioned object, in an aspect, the present invention provides a passive keyless entry device including: a fixed unit; and a portable unit, wherein a wakeup signal and a data signal are wirelessly transmitted from the fixed unit to the portable unit, an instruction signal is wirelessly transmitted from the portable unit receiving the wakeup signal and the data signal to the fixed unit so as to remotely operate a controlled device provided in the fixed unit, and the portable unit includes: three antennas for receiving the wakeup signal and the data signal with respect to three directions which intersect at right angles to one another; three sets of amplifiers and detectors for obtaining detection output from a signal received from each of the antennas; and detection output selection means for selecting one detection output by which the wakeup signal can be detected normally from the detection output which is output from each of the detectors and for extracting and outputting a detection signal of the data signal from the one detection output

For wireless communication between the fixed unit and the portable unit in the passive keyless entry device, since the area of the near field is as wide as 200 to 300 m, a low-frequency band (125 KHz in the current situation) is used. The magnetic field in the near field, as shown in FIG. 7, is formed of the magnetic-field vector Hr in the radial direction and the magnetic-field vector Hθ in the θ direction. Similarly to this, the electromagnetic waves emitted from vehicle-mounted electrical components such as the fan motor are also formed of the magnetic-field vector Hr in the radial direction and the magnetic-field vector Hθ in the θ direction. Therefore, when three antennas for receiving a transmission signal from the fixed unit are provided with respect to three directions at right angles to each other, the situation in which the Hr components and the Hθ components of the transmission signal from the fixed unit and the Hr components and the Hθ components of the interference waves completely overlap with each other in each of the three antennas and are superposed is practically very rare. It is often that, with respect to one antenna input, even if the strength of the transmission signal from the fixed unit is higher than the strength of the interference waves, the strength of the transmission signal from the fixed unit becomes higher than the strength of the interference waves with respect to the other antenna inputs. Therefore, if one detection output in which the influence of the interference waves is small and by which the wake-up signal can be recognized normally is selected, the detection signal of the data signal can be reliably extracted from the one detection output. As a result, the inconvenience such that the fixed unit erroneously determines that the portable unit is not present inside the vehicle in spite of the fact that the portable unit is disposed inside the vehicle can be overcome. Thus, the reliability of communication between the fixed unit and the portable unit can be improved.

In the passive keyless entry device of the present invention, the detection output selection means includes: a level comparator for comparing a received signal strength of the antenna, which is output from each of the detectors; a selector circuit for selecting and outputting each of the detection outputs which are output from each of the detectors in the order of the magnitude of the received signal strength specified at the level comparator; a storage section in which patterns of the wakeup signal are prestored; and a pattern comparator for comparing the pattern of the wakeup signal, stored in the storage section, with the pattern of the one detection output, which is output from the selector circuit.

The received signal strength (RSSI signal) of the antenna, output from the detector, is proportional to the level of the antenna input, and the possibility that the wake-up signal and interference waves are contained in antenna input having a high received signal strength at a high level is high. Therefore, if each detection output which is output from each detector is selected in the order in which the received signal strength is high in order to perform pattern comparison, and if detection output in which the received signal strength is high and by which the wake-up signal can be detected is selected, detection of a desired detection signal can be performed reliably. Thus, the reliability of communication between the fixed unit and the portable unit can be improved.

In the passive keyless entry device of the present invention, the detection output selection means includes: a storage section in which patterns of the wakeup signal are prestored; three pattern comparators for comparing the pattern of the wakeup signal, stored in the storage section, with the pattern of each of the detection outputs, which are output from each of the detectors; and a selector circuit for selecting one detection output corresponding to a comparison signal output from each of the pattern comparators from among detection outputs which are output from each of the detectors and for extracting and outputting a detection signal of the data signal from the one detection output.

To select desired detection output, it is preassumed that the wake-up signal can be detected, and the minimum requirement is that the wake-up signal can be detected. Therefore, if the detection output by which the wake-up signal can be detected at the pattern comparator is selected by the selector circuit, detection of a desired detection signal can be performed reliably. Thus, the reliability of communication between the fixed unit and the portable unit can be improved.

In the passive keyless entry device of the present invention, the detection output selection means includes: a storage section in which patterns of the wakeup signal are prestored; three pattern comparators for comparing the pattern of the wakeup signal, stored in the storage section, with the pattern of each of the detection outputs, which are output from each of the detectors; and a selector circuit for selecting one detection output corresponding to a comparison signal output from each of the pattern comparators and a received signal strength of the antenna, output from each of the detectors, from among detection outputs which are output from each of the detectors and for extracting and outputting a detection signal of the data signal from the one detection output.

As described above, in order that desired detection output be selected, it is preassumed that the wake-up signal can be detected. Furthermore, even if the wake-up signal can be detected, detection output in which the received signal strength is low is not desirable because the subsequent signal processing is likely to be unstable. Therefore, if the detection output by which the wake-up signal can be detected and in which the received signal strength is high is selected by the selector circuit, the detection of a desired detection signal can be performed even more reliably. Thus, the reliability of communication between the fixed unit and the portable unit can be improved.

As has thus been described, the passive keyless entry device of the present invention includes three antennas for receiving a transmission signal from the fixed unit with respect to three directions at right angles to each other, and selects one detection output in which the received signal strength is high from each detection output which is output from each detector and by which the wake-up signal can be detected. Consequently, the detection signal of the data signal can be reliably extracted from the one detection output. As a result, the inconvenience such that the fixed unit erroneously determines that no portable unit is present inside the vehicle in spite of the fact that the portable unit is present inside the vehicle can be overcome. Thus, the reliability of communication between the fixed unit and the portable unit can be improved.

### BRIEF DESCRIPTION OF THE DRAWINGS

FIG. 1 is a block diagram showing the configuration of a passive keyless entry device according to a first embodiment of the present invention;

FIG. 2 is a waveform chart of signals output from each section which forms the passive keyless entry device according to the first embodiment of the present invention;

FIG. 3 is a block diagram showing the configuration of a passive keyless entry device according to a second embodiment of the present invention;

FIG. 4 is a waveform chart of signals output from each section which forms the passive keyless entry device according to the second embodiment of the present invention;

FIG. 5 is a block diagram showing the configuration of a passive keyless entry device according to a third embodiment of the present invention;

FIG. 6 is a waveform chart of signals output from each section which forms the passive keyless entry device according to the third embodiment of the present invention; and

FIG. 7 is an illustration of a magnetic field in the near field of a low-frequency band.

### DESCRIPTION OF THE PREFERRED EMBODIMENTS

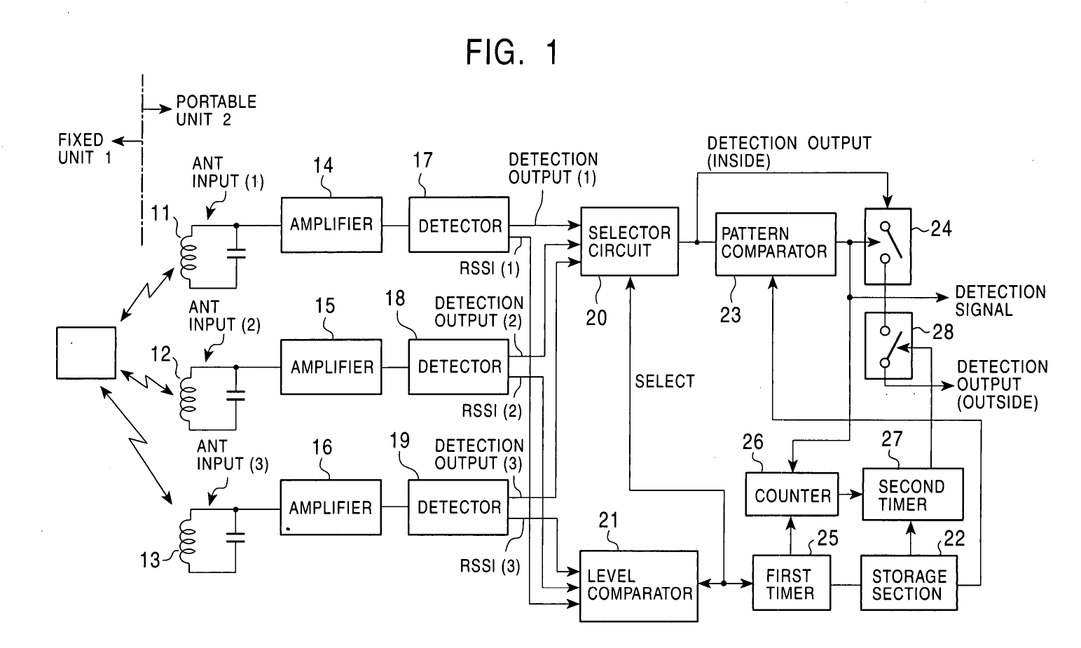

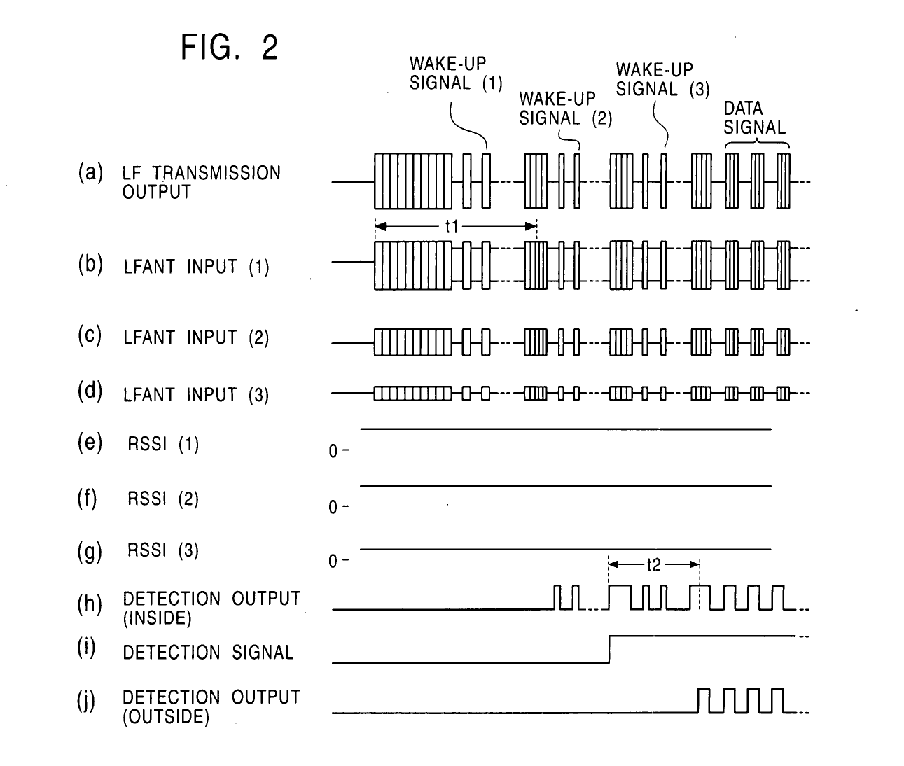

A first example of a passive keyless entry device according to the present invention will now be described below with reference to FIGS. 1 and 2. FIG. 1 is a block diagram showing the configuration of a passive keyless entry device according to a first embodiment of the present invention. FIG. 2 is a waveform chart of signals output from each section which forms the passive keyless entry device according to the first embodiment of the present invention.

As shown in FIG. 1, the passive keyless entry device of this example includes a fixed unit 1 and a portable unit 2. A signal receiving section of the portable unit 2 includes three antennas 11, 12, and 13 for receiving a signal which is wirelessly transmitted from the fixed unit 1 with respect to three directions which are at right angles to one another; three amplifiers 14, 15, and 16 which are connected to the antennas 11, 12, and 13, respectively; three detectors 17, 18, and 19 which are connected to the amplifiers 14, 15, and 16, respectively; a selector circuit 20 for receiving each of detection outputs (1), (2), and (3) output from the detectors 17, 18, and 19 and for outputting one by one at a predetermined sequence and timing; a level comparator 21 for receiving each of RSSI (1), (2), and (3) output from the detectors 17, 18, and 19, respectively, and for outputting a selection signal to the selector circuit 20 in the order in which the received signal strength is high; a storage section 22 in which patterns of a wake-up signal that is wirelessly transmitted from the fixed unit 1 to the portable unit 2, and a timer setting time are prestored; a pattern comparator 23 for comparing the pattern of the wake-up signal stored in the storage section 22 with the pattern of detection output, which is output from the selector circuit 20; a first switch 24 which is turned on/off in accordance with a detection signal output from the pattern comparator 23; a first timer 25 for regulating the output timing of a selection signal from the level comparator 21; a counter 26 for counting the number of outputs of the detection signal from the pattern comparator 23; a second timer 27 for regulating the output timing of detection output from the pattern comparator 23; and a second switch 28 which is turned on/off in accordance with a timer signal from the second timer 27.

The fixed unit 1 is disposed in an automobile. As shown in part (a) of FIG. 2, the fixed unit 1 wirelessly transmits, to the portable unit 2, wake-up signals (1), (2), and (3), and a data signal, which are superposed onto a low-frequency modulation wave of 125 KHz. The wake-up signals (1) to (3) are transmitted at a predetermined time interval by considering the receiving process time of each wake-up signal in the portable unit 2. Also, the data signal is transmitted at the elapse of a predetermined time after the wake-up signal (3) is transmitted. This fixed unit 1 receives an instruction signal from the portable unit 2, and performs control of a controlled device connected to the fixed unit 1, for example, start/stop control of an automobile engine, and locking/unlocking control of an automobile door.

The portable unit 2 performs a process for receiving the wake-up signals (1) to (3) and the data signal, which are wirelessly transmitted from the fixed unit 1, and thereafter, wirelessly transmits a predetermined instruction signal to the fixed unit 1 so as to remotely operate the controlled device connected to the fixed unit 1. The process for receiving the wake-up signals (1) to (3) and the data signal in the portable unit 2 is performed in the following procedure.

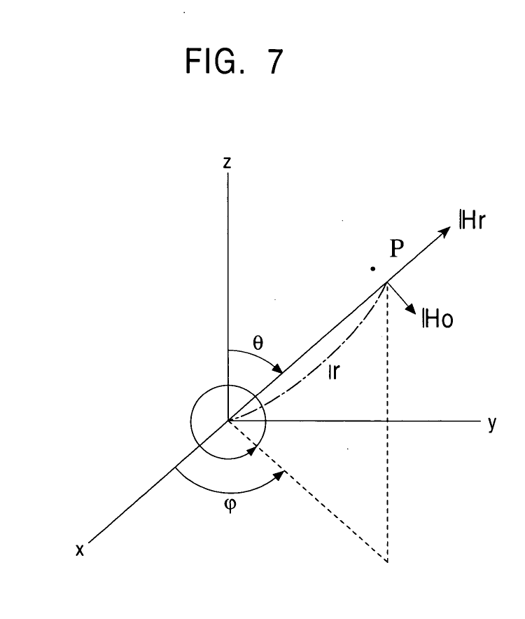

That is, when the portable unit 2 is disposed inside a vehicle, the transmission signal shown in part (a) of FIG. 2 from the fixed unit 1 and interference waves emitted from the electrical components mounted in the vehicle are received by each of the three antennas 11, 12, and 13 provided in the portable unit 2. As described above, the magnetic field in the near field of a low frequency used for wireless transmission between the fixed unit 1 and the portable unit 2, and the magnetic field of interference waves emitted from electrical components mounted in the vehicle are formed of the magnetic-field vector Hr in the radial direction and the magnetic-field vector Hθ in the θ direction (see FIG. 7). As a result, the transmission signal from the fixed unit 1 and interference waves from the vehicle-mounted electrical components are received at mutually different levels by the three antennas 11, 12, and 13 for receiving a signal with respect to three directions at right angles to one another, as shown in parts (b), (c), and (d) of FIG. 2. In this example, the transmission signal and interference waves are received at the highest level by the antenna 11, the transmission signal and the interference waves are received at the lowest level by the antenna 13, and the transmission signal and the interference waves are received at a level intermediate between them by the antenna 12. At this time, as shown in parts (e), (f), and (g) of FIG. 2, regarding the RSSI (1), (2), and (3) output from the detectors 17, 18, and 19, respectively, the received signal strength RSSI (1) of the antenna 11 is the highest, the received signal strength RSSI (3) of the antenna 13 is the lowest, and the received signal strength RSSI (2) of the antenna 12 is a value intermediate between them.

The level comparator 21 compares the RSSI (1), (2), and (3) output from the detectors 17, 18, and 19, and outputs a selection signal to the selector circuit 20 at a timing set in the first timer 25 in the order in which the received signal strength is high.

Upon receiving the selection signal from the level comparator 21, the selector circuit 20 selects and outputs one detection output corresponding to the selection signal from among the detection outputs (1), (2), and (3) output from the detectors 17, 18, and 19. In the case of this example, first, the detection output (1) of the detector 17, having the highest received signal strength, is output from the selector circuit 20. Then, at the pattern comparator 23, the pattern of the detection output (1) is compared with the pattern of the wake-up signal stored in the storage section 22. As shown in part (b) of FIG. 2, regarding the antenna input of the antenna 11, since the wake-up signal transmitted from the fixed unit 1 is buried in the interference waves from the vehicle-mounted electrical components, as shown in part (h) of FIG. 2, the wake-up signal (1) does not appear in the detection signal of the detector 17, and therefore, no detection signal is output from the pattern comparator 23.

In this case, the level comparator 21 outputs, to the selector circuit 20, a selection signal for selecting the detection output (2) having the second highest received signal strength at the elapse of a set time T1 of the first timer 25. Upon receiving the output of the selection signal from the level comparator 21, the selector circuit 20 outputs the detection output (2). The pattern comparator 23 compares the pattern of the detection output (2) with the pattern of the wake-up signal stored in the storage section 22. As shown in part (c) of FIG. 2, regarding the antenna input of the antenna 12, since the transmission signal from the fixed unit 1 is not buried in the interference waves from the vehicle-mounted electrical components, the wake-up signal (2) appears in the detection output (2) of the detector 18. Therefore, a detection signal shown in part (i) of FIG. 2 is output from the pattern comparator 23.

When the detection signal is output from the pattern comparator 23, since the objective of detecting the wake-up signal is achieved, the selection process by the selector circuit 20 with respect to the detection output (3) output from the detector 19 is omitted. That is, the first switch 24 is turned on in accordance with the output of the detection signal from the pattern comparator 23, and also, the second switch 28 is turned on at the elapse of a processing time t2 regarding the detection output (3) set in the second timer 27, and the detection output shown in part (j) of FIG. 2 is output externally.

The passive keyless entry device of this example includes three antennas 11, 12, and 13 for receiving a transmission signal from the fixed unit 1 with respect to three directions which are at right angles to one another, selects the detection outputs (1), (2), and (3) output from the detectors 17, 18, and 19 in the order in which the received signal strength is high, and selects one detection output in which the received signal strength is high and by which the wake-up signal can be detected. As a result, the detection signal of the data signal can be extracted reliably from the one detection output. The inconvenience such that the fixed unit 1 erroneously determines that no portable unit is present inside the vehicle in spite of the fact that the portable unit 2 is placed inside the vehicle can be overcome. Thus, the reliability of communication between the fixed unit 1 and the portable unit 2 can be improved.

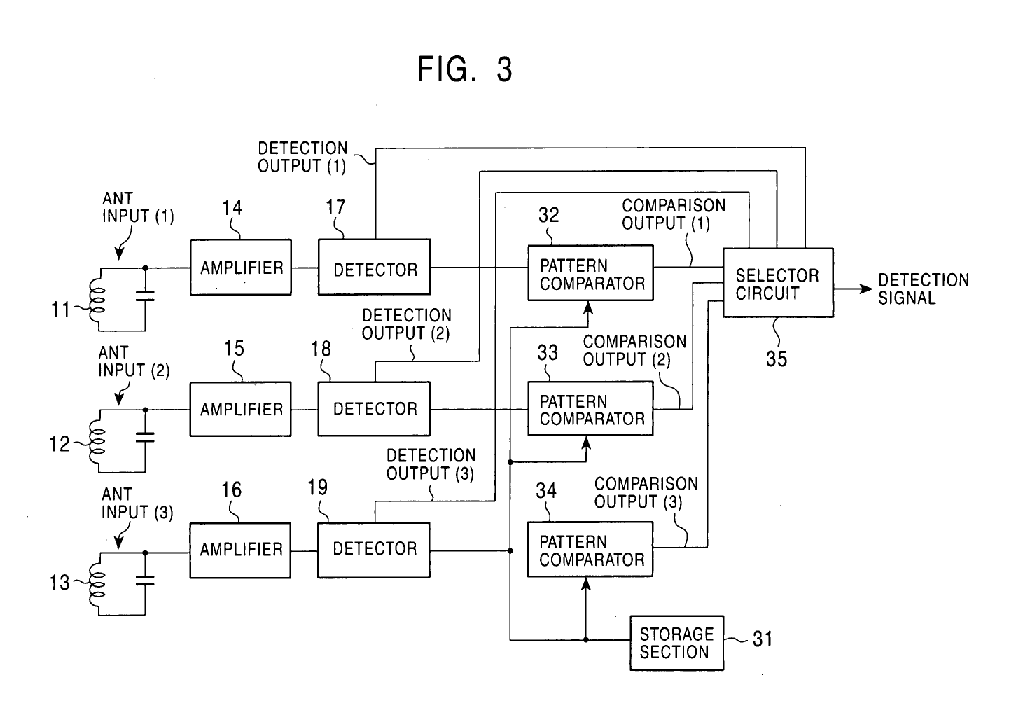

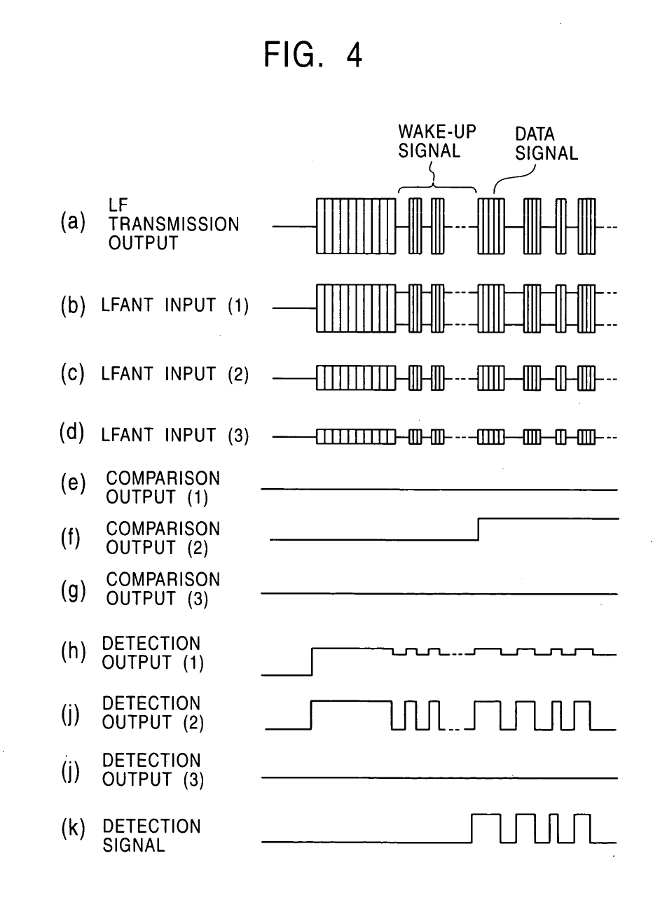

Next, a second example of the passive keyless entry device according to the present invention will be described below with reference to FIGS. 3 and 4. FIG. 3 is a block diagram showing the configuration of a passive keyless entry device according to a second embodiment of the present invention. FIG. 4 is a waveform chart of signals output from each section which forms the passive keyless entry device according to the second embodiment of the present invention.

As shown in FIG. 3, in the passive keyless entry device of this example, detection output selection means provided in the signal receiving section of the portable unit 2 includes a storage section 31 in which patterns of the wake-up signal that is wirelessly transmitted from the fixed unit 1 to the portable unit 2 are prestored; three pattern comparators 32, 33, and 34 for comparing the patterns of the wake-up signal stored in the storage section 31 with the patterns of the detection outputs (1), (2), and (3) output from the detectors 17, 18, and 19; and a selector circuit 35 for receiving the detection outputs (1), (2), and (3) output from the detectors 17, 18, and 19, selecting one detection output corresponding to the comparison signals (1), (2), and (3) output from the pattern comparators 32, 33, and 34, and extracting and outputting the detection signal of the data signal from the one detection output. The remaining construction is the same as the passive keyless entry device according to the first embodiment shown in FIG. 1. Accordingly, a description thereof is omitted by giving the same reference numerals to the corresponding components.

In the passive keyless entry device of this example, the process for receiving the wake-up signals (1), (2), and (3) and the data signal by the portable unit 2 is performed in the following procedure.

That is, when the signal shown in part (a) of FIG. 4 is transmitted from the fixed unit 1 to the portable unit 2, and the transmission signal and the interference waves emitted from the vehicle-mounted electrical components are received by the three antennas 11, 12, and 13 provided in the portable unit 2, as shown in parts (b), (c), and (d) of FIG. 4, the transmission signal and the interference waves are received at the highest level by the antenna 11, the transmission signal and the interference waves are received at the lowest level by the antenna 13, and the transmission signal and the interference waves are received at a level intermediate between them by the antenna 12. As a result, as shown in parts (h), (i), and (j) of FIG. 4, when the detection output (1) of the detector 17 becomes a waveform buried in the interference waves, no detection output is output from the detector 19, and only the detection output (2) of the detector 18 becomes a waveform corresponding to the transmission signal from the fixed unit 1, as shown in parts (e), (f), and (g) of FIG. 4, the comparison output (2) indicating that the pattern of the detection output matches the wake-up signal which is prestored in the storage section 31 is output from only the pattern comparator 33 for performing pattern comparison with respect to the detection output (2). Therefore, the selector circuit 35 selects the detection output (2) of the detector 18, corresponding to the comparison output (2), and extracts the detection signal of the data signal shown in part (k) of FIG. 4 from the detection output (2). This completes the process for receiving the transmission signal from the fixed unit 1.

In the passive keyless entry device of this example, since the detection outputs of the detectors 17, 18, and 19 by which the wake-up signal can be detected at the pattern comparators 32, 33, and 34 are selected at the selector circuit 35, the detection of a desired detection signal can be performed reliably. Thus, the reliability of communication between the fixed unit 1 and the portable unit 2 can be improved.

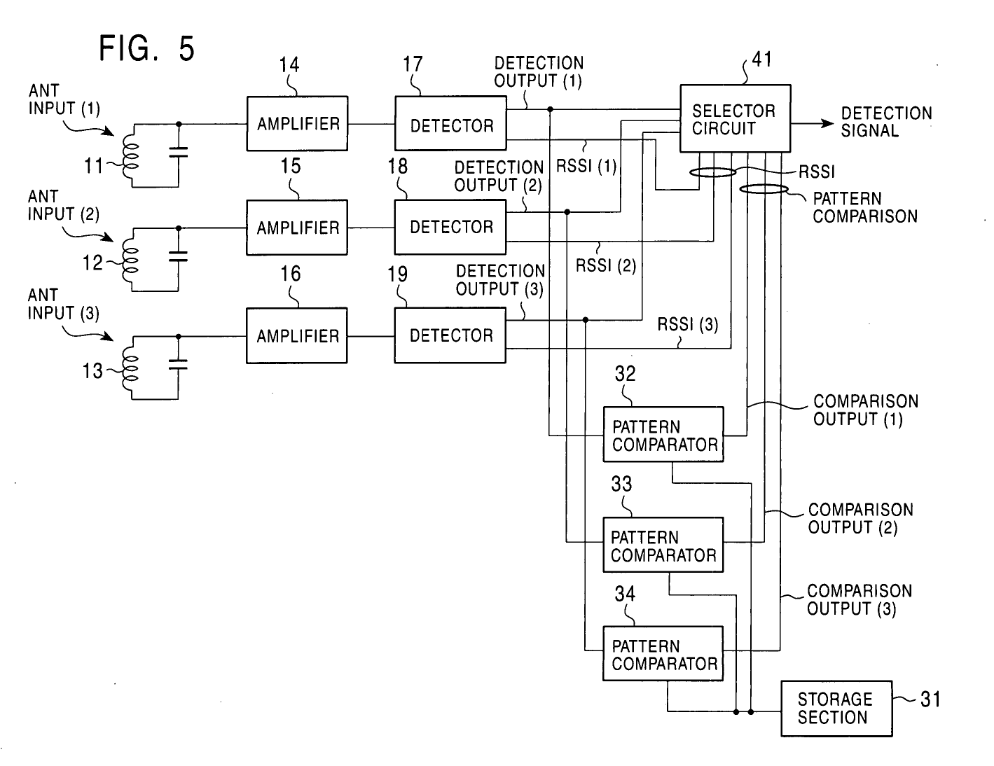

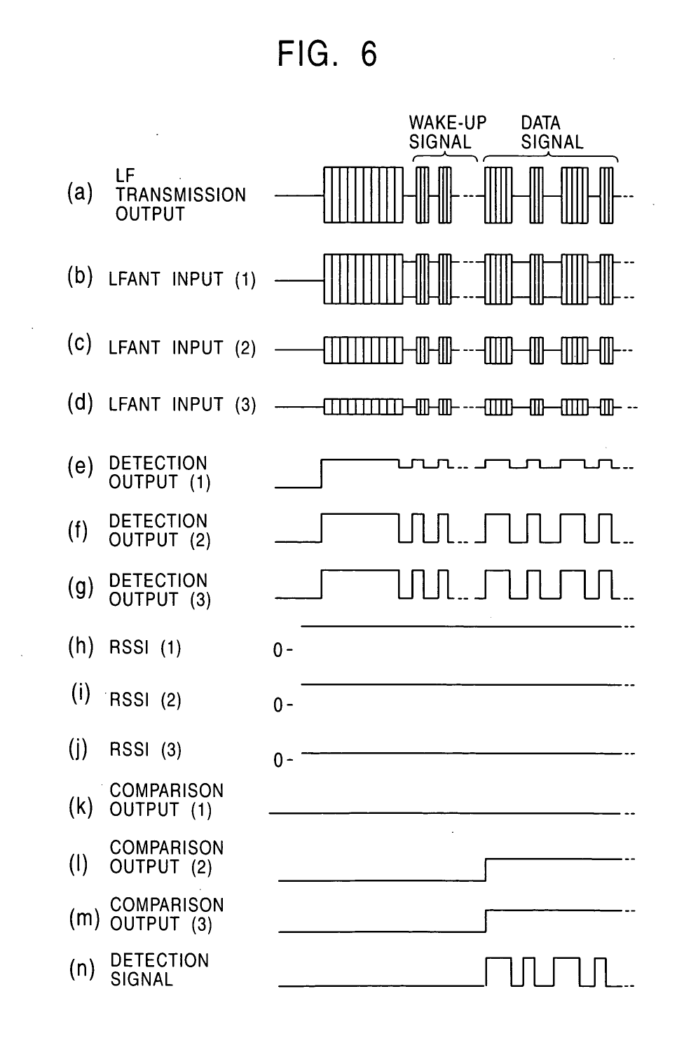

Next, a third example of the passive keyless entry device according to the present invention will now be described below with reference to FIGS. 5 and 6. FIG. 5 is a block diagram showing the configuration of a passive keyless entry device according to a third embodiment of the present invention. FIG. 6 is a waveform chart of signals output from each section which forms the passive keyless entry device according to the third embodiment of the present invention.

As shown in FIG. 5, in the passive keyless entry device of this example, detection output selection means provided in the signal receiving section of the portable unit 2 includes a storage section 31 in which patterns of the wake-up signal that is wirelessly transmitted from the fixed unit 1 to the portable unit 2 are prestored; three pattern comparators 32, 33, and 34 for comparing the patterns of the wake-up signal stored in the storage section 31 with the patterns of the detection outputs (1), (2), and (3) output from the detectors 17, 18, and 19; and a selector circuit 41 for receiving the detection outputs (1), (2), and (3) and the RSSI (1), (2), and (3), which are output from the detectors 17, 18, and 19, and selecting and outputting one detection output by which the wake-up signal is detected and in which the received signal strength is high. The remaining construction is the same as the passive keyless entry device according to the first embodiment shown in FIG. 1 and the passive keyless entry device according to the second embodiment shown in FIG. 3. Accordingly, a description thereof is omitted by giving the same reference numerals to the corresponding components.

In the passive keyless entry device of this example, the process for receiving the wake-up signals (1), (2), and (3) and the data signal by the portable unit 2 is performed in the following procedure.

That is, when the signal shown in part (a) of FIG. 6 is transmitted from the fixed unit 1 to the portable unit 2, and the transmission signal and interference waves emitted from the vehicle-mounted electrical components are received by the three antennas 11, 12, and 13 provided in the portable unit 2, as shown in parts (b), (c), and (d) of FIG. 6, the transmission signal and the interference waves are received at the highest level by the antenna 11, the transmission signal and the interference waves are received at the lowest level by the antenna 13, and the transmission signal and the interference waves are received at the level intermediate between them by the antenna 12. As a result, as shown in parts (e), (f), and (g) of FIG. 6, when the detection output (1) of the detector 17 becomes a waveform buried in the interference waves, and the detection output (2) of the detector 18 and the detection output (3) of the detector 19 becomes waveforms corresponding to the transmission signal from the fixed unit 1, as shown in parts (k), (l), and (m) of FIG. 6, the comparison output (2) and comparison output (3) indicating that the pattern of the detection output matches the wake-up signal which is prestored in the storage section 31 are output from the pattern comparator 33 for performing pattern comparison with respect to the detection output (2) and the pattern comparator 34 for performing pattern comparison with respect to the detection output (3). Furthermore, as shown in parts (h), (i), and (j) of FIG. 6, regarding RSSI (1), (2), and (3) output from the detectors 17, 18, and 19, RSSI (1) output from the detector 17 is the highest, RSSI (3) output from the detector 19 is the lowest, and RSSI (2) output from the detector 18 becomes a value intermediate between them. Even if the wake-up signal can be detected, regarding detection output in which the received signal strength is low, signal processing after that detection is likely to become unstable. Therefore, the selector circuit 41 selects the detection output (2) by which the wake-up signal can be detected and in which the received signal strength is comparatively high, and extracts the detection signal of the data signal shown in part (n) of FIG. 6 from the detection output (2). This completes the process for receiving the transmission signal from the fixed unit 1.

In the passive keyless entry device of this example, since the wake-up signal can be detected, and the detection output (2) having the high received signal strength is selected by the selector circuit 41, the detection of a desired detection signal can be performed even more reliably. Thus, the reliability of communication between the fixed unit 1 and the portable unit 2 can be improved.

In the above-described embodiments, although a description is given by using as an example a vehicle-mounted passive keyless entry device, the present invention is not restricted to this example. Alternatively, the present invention can also be applied to a passive keyless entry device used for other purposes, such as door locking/unlocking of a housing.

1. A passive keyless entry device comprising:
a fixed unit; and
a portable unit,
wherein a wakeup signal and a data signal are wirelessly transmitted from said fixed unit to said portable unit, an instruction signal is wirelessly transmitted from said portable unit receiving said wakeup signal and said data signal to said fixed unit so as to remotely operate a controlled device provided in said fixed unit, and
said portable unit comprises:
three antennas for receiving said wakeup signal and said data signal with respect to three directions which intersect at right angles to one another;
three sets of amplifiers and detectors for obtaining detection output from a signal received from each of said antennas; and
detection output selection means for selecting one detection output by which said wakeup signal can be detected normally from the detection output which is output from each of said detectors and for extracting and outputting a detection signal of said data signal from the one detection output.

2. A passive keyless entry device according to claim 1, wherein said detection output selection means comprises:
a level comparator for comparing a received signal strength of said antenna, which is output from each of said detectors;
a selector circuit for selecting and outputting each of said detection outputs which are output from each of said detectors in the order of the magnitude of said received signal strength specified at said level comparator;
a storage section in which patterns of said wakeup signal are prestored; and
a pattern comparator for comparing the pattern of said wakeup signal, stored in the storage section, with the pattern of said one detection output, which is output from said selector circuit.

3. A passive keyless entry device according to claim 1, wherein said detection output selection means comprises:
a storage section in which patterns of said wakeup signal are prestored;
three pattern comparators for comparing the pattern of said wakeup signal, stored in the storage section, with the pattern of each of said detection outputs, which are output from each of said detectors; and
a selector circuit for selecting one detection output corresponding to a comparison signal output from each of said pattern comparators from among detection outputs which are output from each of said detectors and for extracting and outputting a detection signal of said data signal from the one detection output.

4. A passive keyless entry device according to claim 1, wherein said detection output selection means comprises:
a storage section in which patterns of said wakeup signal are prestored;
three pattern comparators for comparing the pattern of said wakeup signal, stored in the storage section, with the pattern of each of said detection outputs, which are output from each of said detectors; and
a selector circuit for selecting one detection output corresponding to a comparison signal output from each of said pattern comparators and a received signal strength of said antenna, output from each of said detectors, from among detection outputs which are output from each of said detectors and for extracting and outputting a detection signal of said data signal from the one detection output.
